(19) United States
(12) Patent Application Publication
(10) Pub. No.: US 2008/0136815 A1
(43) Pub. Date: Jun. 12, 2008

(54) Image display controlling apparatus, image display controlling program and image display controlling method

(75) Inventor: Kazuhiko Matsumoto, Tokyo (JP)

Correspondence Address: YOUNG & THOMPSON, 209 Madison Street, Suite 500, ALEXANDRIA, VA, 22314, US

(73) Assignee: ZIOSOFT, INC., Tokyo (JP)

(21) Appl. No.: 11/984,921

(22) Filed: Nov. 26, 2007

(30) Foreign Application Priority Data
Dec. 12, 2006 (JP) 2006-334936

(51) Int. Cl. G06T 15/00

(52) U.S. Cl. 345/419

(57) ABSTRACT

An image display controlling apparatus for displaying three-dimensional information of an object to be examined on a display unit, includes: a planar image obtaining device; a display planar image designating device; a display limit information obtaining device; a display ability judgment device; a synthesis rate obtaining device; a synthesizing device for producing a synthesis image; and a display control device for displaying the synthesis image thus produced on the display device.

### BACKGROUND OF THE INVENTION

1. Field of the Invention

The present invention relates to an image display controlling apparatus for displaying a plurality of planar images constituting three-dimensional information of an object to be examined, specifically to an image display controlling apparatus of displaying beyond display limit of a display means.

2. Related Art

One type of an image displaying method is typically carried out by designating an image which a user requires to display on a display unit such as a monitor to thereby display the image thus designated on the display unit.

For example, as shown in FIG. 6, there is a case where an object to be examined is laid on a table and acquired by computer tomography (CT), and a slice image thus acquired is displayed on a display unit. When a CT with multi-detecters is used, it is possible to obtain such slice images from the object to be examined at a minute interval of such as 0.5 mm. For example, when an object to be examined is acquired from his or her neck to ankle for diagnosing the cardiovascular system, a large number of slice images are obtained, and therefore three-dimensional information of the object to be examined is obtained.

FIGS. 7 and 8 are explanatory views for showing states that a user browses a plurality of slice images by displaying these on the display unit. The slice images are sequentially displayed when a user moves a cursor on a scroll bar, a slice image corresponding to a cursor position is sequentially displayed out of a plurality of slice images. For example, as shown in FIG. 8, when the cursor is at a position e on the scroll bar, the E-th slice image corresponding to the position e is displayed on the display unit. When the cursor is at a position f on the scroll bar, the F-th slice image corresponding to the position f is displayed on the display unit. Thereafter, G-th and H-th slice images respectively corresponding to positions g and h are displayed on the display unit by moving the cursor.

In other words, slowly moving the cursor from the position e on the scroll bar to the position h, all slice images corresponding to each of the cursor positions are in order displayed on the display unit sequentially from the G-th slice image to the H-th slice image.

Further, in Japanese Unexamined Patent Publication JP-A-07-99634, a technique of combining a plurality of frames in reproducing video data at a reproduction rate designated from variable rates.

However, when a movement speed of a mouse runs out of limit of display processing ability (e.g. frame rate), handling in a case where a cursor is quickly moved, a position of cursor does not match dynamically a slice image displayed on the display unit. For example, when a cursor is moved from a position e on a scroll bar to a position h within a short time, e.g. one second, the display unit still displays an F-th slice image, even though the cursor is at the position h on the scroll bar. As such there is a case where a displayed slice image delays against a slice image to be displayed in correspondence with the position of cursor.

Under such the state, a user may try to match position of a cursor with a slice image corresponding to the position of the cursor. In other words, in the case of the above state, a user who recognizes that the F-th slice image is displayed on the display unit tries to move the cursor in the vicinity of the position f. However, while the user confirms the F-th slice image on the display unit and maneuvers an operation unit to move the cursor in the vicinity of the position f on the scroll bar, since the display unit is instructed to sequentially display slice images up to the H-th slice image in accordance with the position h of the cursor, there may be a case where the display unit does not display the F-th slice image even though the cursor is at the position f.

As such, when the user moves the cursor to designate the slice image to be displayed, there is a problem that the slice image corresponding to the position of the cursor cannot be displayed in a range running out of limit of display processing ability of the display unit like 60 images per second.

One solution to deal with such problems is to ensure that slice image corresponding to a position of cursor is constantly displayed on the display unit by culling slice images exceeding upper limit number of images to be displayed. However, when the slice images are used for medical diagnosing purpose, there is risk of culling a slice image having lesion on it. Therefore, the culling is not appropriate.

Further, it is also possible to present solution such that the cursor is restricted to move within a range of the upper limit number of displaying image on the display unit. However, when a number of the slice images are large like several thousands or several tens of thousands, there is a problem that an excessive time is necessary to check the slice images in compliance with the upper limit number of displaying image.

Meanwhile, a plurality of slice images may be degenerated to fewer slices by statically synthesizing images, and the degenerated slice images may be used in diagnosis. However, such the process rather spoils excellent performance of multi-detector CT apparatus.

### SUMMARY OF THE INVENTION

The present invention is provided in consideration of the above problems. An object of an illustrative, non-limiting embodiment of the present invention to provide an image display control apparatus or the like which can display a large number of slice images without loss by dynamically obtaining synthesis image of images to be displayed together with a synthesis rate when it is instructed that images exceeding an upper limit number of displaying image on a display means such as a monitor.

According to a first aspect of an illustrative, non-limiting embodiment of the present invention, there is provided an image display controlling apparatus for displaying three-dimensional information of an object to be examined including:

a planar image acquiring device for acquiring a plurality of planar images from the three-dimensional information;

a display planar image designating device for designating a plurality of target planar images to be displayed included in the plurality of planar images;

a display limit information obtaining device for obtaining display limit information indicative of an upper limit number of displaying the planar images displayed per a predetermined time with the display device;

a display ability judgment device for judging whether or not it is possible to display the plurality of target planar images on the basis of the display limit information;

a synthesis rate obtaining device for obtaining, when it is judged that display is impossible by the display ability judgment device, a synthesis rate for converting a number of the planar images per the predetermined time on the basis of the upper limit number of displaying the planar images to a number less than the upper limit number of displaying planar images;

a synthesizing device for producing a plurality of synthesis images by synthesizing the plurality of target planar images in use of the synthesis rate; and

a display control device for displaying the plurality of synthesis images thus produced on the display device.

According to this aspect, even when is judged that display is impossible after judging whether or not a plurality of target planar images to be displayed based on display limit information on the display device, it is possible to make a synthesis image by synthesizing target planar images by dynamically obtaining a synthesis rate on the basis of an upper limit number of displaying image and effectively display the plurality of target planar images to be displayed without loss.

According to a second aspect of an illustrative, non-limiting embodiment of the present invention, there is provided an image display controlling apparatus according to the first aspect of the invention, wherein the synthesizing means includes a synthesis adequacy judgment device for judging whether or not it is inadequate to synthesize a specific set of target planar images, and excludes the specific set of target planar images from the synthesis when it is judged to be inadequate.

According to this aspect, it is possible to prevent information of the plurality of images having different properties and features form being spoiled as a result of the synthesis.

According to a third aspect of an illustrative, non-limiting embodiment of the present invention, there is provided an image display controlling apparatus according to the preceding aspects of the invention, wherein the display planar image designating means includes

a synthesis rate limiting device to make a synthesis rate less than a predetermined number when the synthesis rate of a predetermined number or more is detected.

According to this, it is possible to limit the number of synthesizing images.

According to a fourth aspect of an illustrative, non-limiting embodiment of the present invention, there is provided an image display control apparatus according to the preceding aspects of the invention, wherein

the display control device displays the synthesis rate on the display device.

According to this, since the synthesis rate can be presented to a user, the user can objectively judge a degree of alteration of image or the like after the image synthesis.

According to a fifth aspect of an illustrative, non-limiting embodiment of the present invention, there is provided an image display control apparatus according to the preceding aspects of the invention, wherein

the synthesizing device produces the synthesis image by using an average value, a maximum value, or a minimum value of pixels forming the target planar image.

According to a sixth aspect of an illustrative, non-limiting embodiment of the present invention, there is provided an image display control apparatus according to the preceding aspects of the invention, wherein

the planar image is an MPR image of the object to be examined.

According to a seventh aspect of an illustrative, non-limiting embodiment of the present invention, there is provided an image display control apparatus according to the preceding aspects of the invention, wherein

the planar image is a planar image in any one of directions of axial, coronal, and sagittal.

According to an eighth aspect of an illustrative, non-limiting embodiment of the present invention, there is provided an image display control apparatus according to the preceding aspects of the invention, wherein

the display planar image designating device designates the target planar image out of the plurality of planar images upon operation of the operation device by a user.

According to a ninth aspect of an illustrative, non-limiting embodiment of the present invention, there is provided an image display control apparatus according to the preceding aspects of the invention, wherein

the upper limit number of displaying planar image per a predetermined time is designated when the user operates the operating device.

According to a tenth aspect of an illustrative, non-limiting embodiment of the present invention, there is provided an image display control apparatus according to the preceding aspects of the invention, wherein

the plurality of planar images are obtained from another computer through a network, and

the upper limit number of displaying planar image per predetermined time is determined by at least a transfer speed of the network.

According to an eleventh aspect of an illustrative, non-limiting embodiment of the present invention, there is provided a computer program embodied in a computer-readable medium and representing a sequence of instructions, which when executed by a computer included in an image display controlling apparatus for displaying three-dimensional information of an object to be examined on a display device, the instructions cause the computer to function as:

a planar image acquiring device for acquiring a plurality of planar images from the three-dimensional information;

a display planar image designating device for designating a plurality of target planar images to be displayed included in the plurality of planar images;

a display limit information obtaining device for obtaining display limit information indicative of an upper limit number of displaying the planar images per a predetermined time with the display device;

a display ability judgment device for judging whether or not it is possible to display the plurality of target planar images on the basis of the display limit information;

a synthesis rate obtaining device for obtaining, when it is judged that display is impossible by the display ability judgment device, a synthesis rate for converting a number of the planar images per the predetermined time on the basis of the upper limit number of displaying the planar images to a number less than the upper limit number of displaying planar images;

a synthesizing device for producing a synthesis image by synthesizing the plurality of target planar images in use of the synthesis rate; and

a display control device for displaying the synthesis image thus produced on the display device.

According to a twelfth aspect of an illustrative, non-limiting embodiment of the present invention, there is provided an image display controlling method of displaying three-dimensional information of an object to be examined on a display device, including:

a planar image acquiring step of acquiring a plurality of planar images from the three-dimensional information;

a display planar image designating step of designating a plurality of target planar images to be displayed included in the plurality of planar images;

a display limit information obtaining step of obtaining display limit information indicative of an upper limit number of displaying the planar images per a predetermined time in the display device;

a display ability judgment step of judging whether or not it is possible to display the plurality of target planar images on the basis of the display limit information;

a synthesis rate obtaining step of obtaining, when it is judged that display is impossible in the display ability judgment step, a synthesis rate for converting a number of the planar images per the predetermined time on the basis of the upper limit number of displaying the planar images to a number less than the upper limit number of displaying planar images;

a synthesizing step of producing a plurality of synthesis images by synthesizing the plurality of target planar images in use of the synthesis rate; and

a display control step of displaying the synthesis image thus produced on the display device.

### BRIEF DESCRIPTION OF THE DRAWINGS

In the accompanying drawings:

FIG. 1 is a block chart for showing structure of an image display apparatus according to a non-limiting embodiment of the present invention.

FIG. 2 is an explanatory view for showing how slice images to be displayed are designated.

FIG. 3 is an explanatory view for showing how slice images to be displayed are designated.

FIG. 4 is a flowchart for showing an image display control process in a control unit 11.

FIG. 5 shows an example of a method of displaying a synthesis rate.

FIG. 6 is an explanatory view of slice images acquired by CT scan.

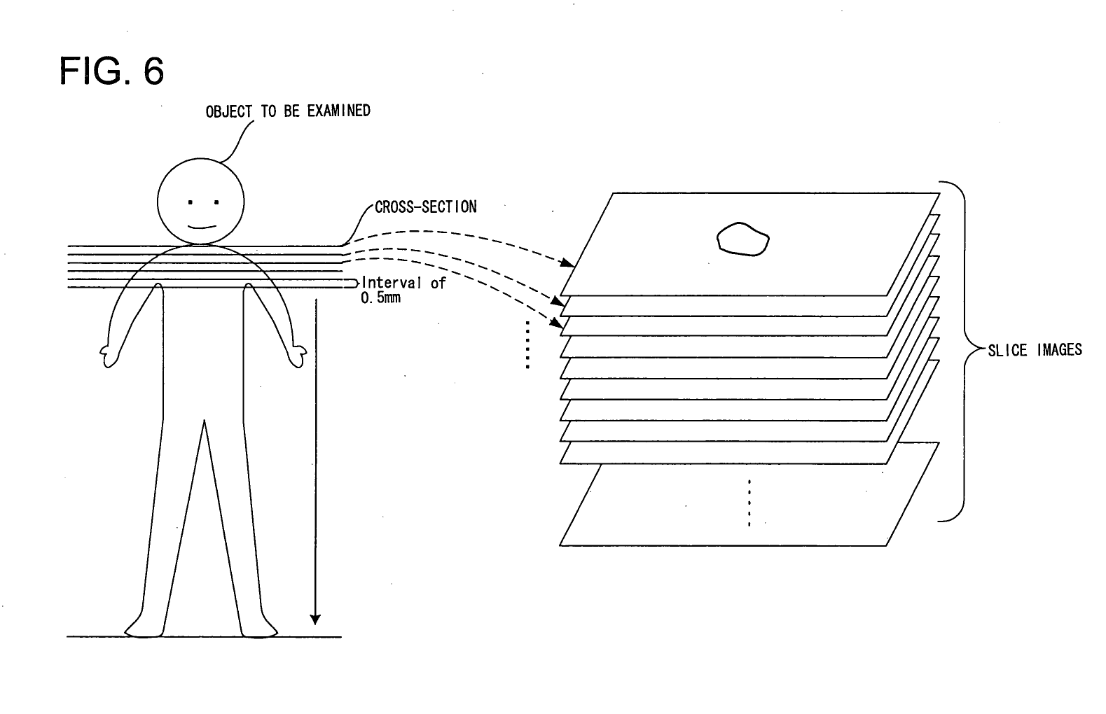

FIG. 7 is an explanatory view for showing how slice images to be displayed are displayed for a user.

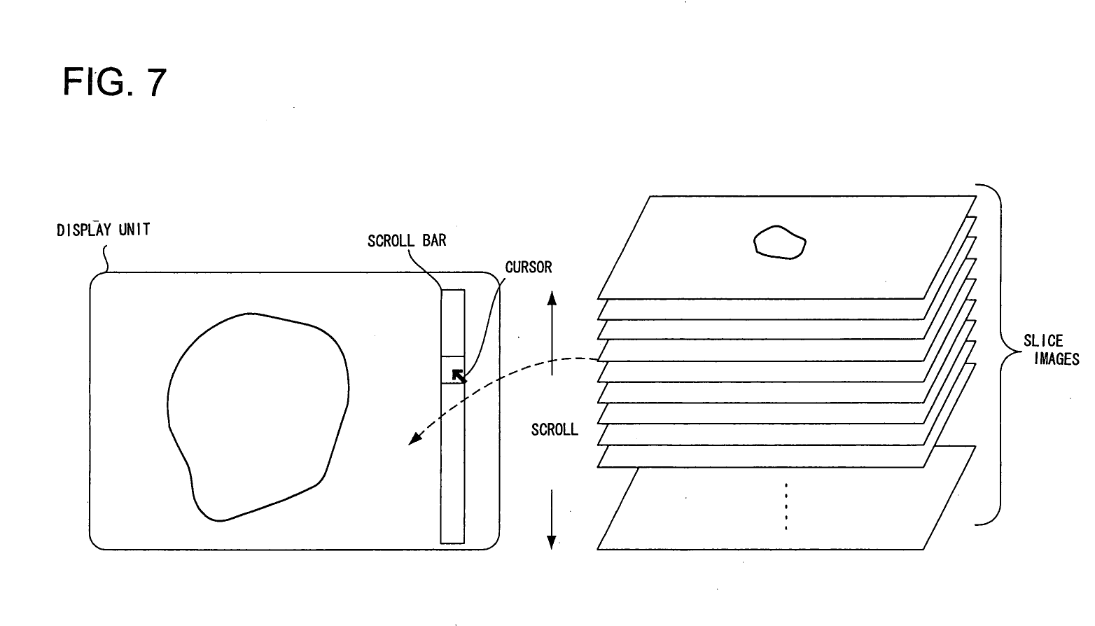

FIG. 8 is an explanatory view for showing how slice images to be displayed are displayed for a user.

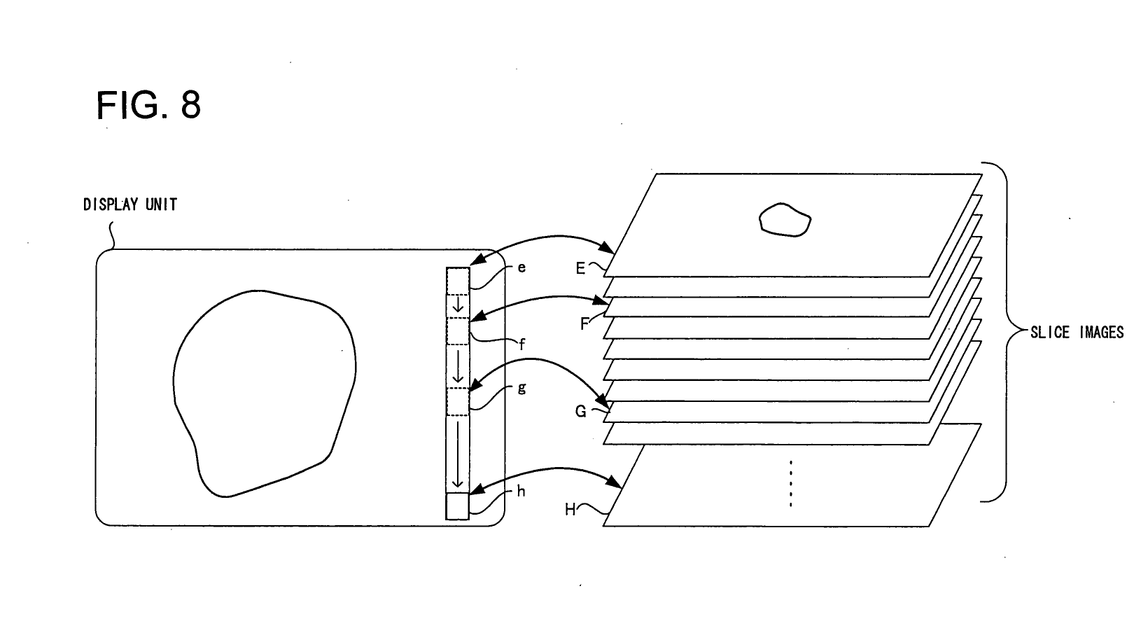

### DESCRIPTION OF THE PREFERRED EMBODIMENTS

Preferred embodiments of the present invention will be described in conjunction with figures. Hereinafter, each meaning of the reference numbers in the drawings is as follows:

1:IMAGE DISPLAY DEVICE, 11: CONTROL UNIT, 13:MEMORY UNIT, 13A: IMAGE MEMORY UNIT, 14: DISPLAY UNIT, 15: OPERATION UNIT, 16: BUS, max_num: upper limit number of displaying image per second, new_id: identification number of slice image currently designated, current_id: identification number of slice image previously designated, interval_time: time interval between previous designation and current designation, and per_image: number of slice images synthesized at each display.

In this embodiment, a case where the image display control apparatus according to the present invention is applied to an image display apparatus 1 for displaying a slice image designated in response to instruction by a user out of a plurality of slice images (an example of planar images in the present invention) constituting three dimensional information which is acquired by scanning an object to be examined (an example of object to be examined according to the present invention), which is laid on a table or the like.

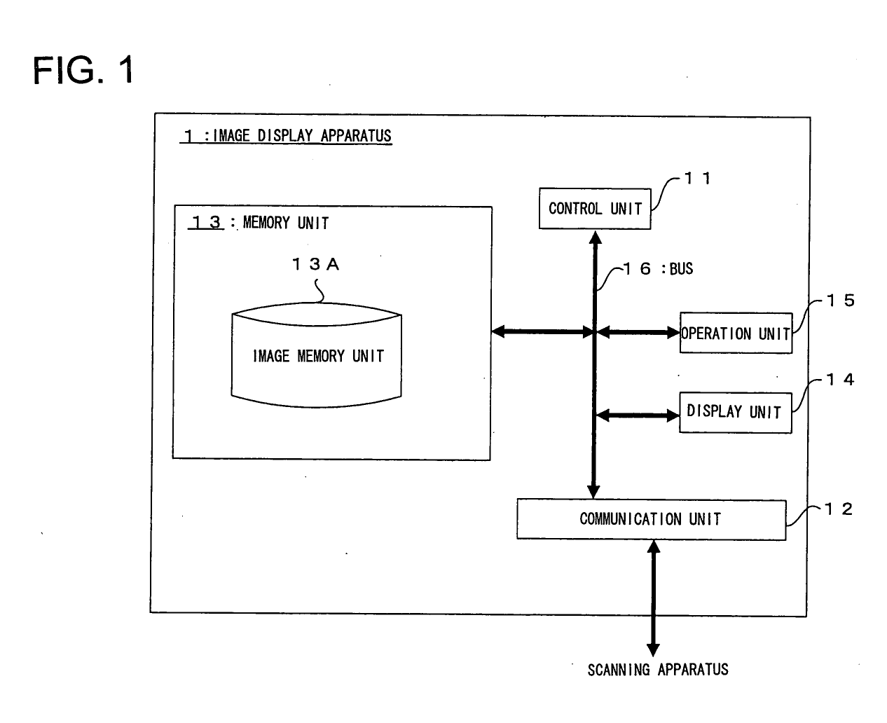

FIG. 1 is a block chart for showing a structure of image display apparatus according to this embodiment. As illustrated in FIG. 1, the image display apparatus 1 is constituted by a control unit 11 made up of such as a central processing unit (CPU), a working random access memory (RAM), a read only memory (ROM) for memorizing various data and a program; a communication unit 12 for taking the plurality of slice images inside the apparatus from another scanning apparatus, and a database and a server apparatus both of which store slice images in an axial direction of the object to be examined extracted out of three dimensional information of the object to be examined via a network; a memory unit 13 including a image memory unit 13 A for memorizing the slice images which are taken inside the apparatus via the communication unit 12; a display unit 14 as a display means for displaying the slice image designated by operating the operation unit 15 and a synthesis image produced in accordance with the image display controlling method of the present invention; and an operation unit 15 which functions as an operating means and a display planar image designating means and made up of, for example, a keyboard, a mouse, a wheel rotating mechanism, or an operation panel in order to receive an instruction by a user and apply an instruction signal in response to the instruction to the CPU, and especially to designate a slice image to be displayed out of the plurality of slice images thus memorized in the image memory unit 13A, wherein the control unit 11, the communication unit 12, the memory unit 13, the display unit 14, and the operation unit 15 are mutually connected through a bus 16.

The control unit 11 is constituted by, for example, a CPU, a work RAM, a ROM memorizing various control program including the image display control program according to the present invention or the like, data, and so on, an oscillating circuit, or the like (not shown). The control unit 11 generates control information for controlling the above constitutional elements in order to execute operation corresponding to the control information contained in the operation signal, and outputs the control information to the constitutional elements corresponding to the control information via the bus 16, to thereby totally control the operation of each of the constitutional elements.

Further, the control unit 11 carries out the image display control program memorized in the ROM or the like to thereby function as a planar image acquiring means, a display planar image designating means, a display limit information obtaining means, a display ability judgment means, a synthesis rate obtaining means, a synthesizing means, a display control means, and a synthesis adequacy judgment means.

Although the display unit 14 is built inside the image display apparatus 1 in the present embodiment, a monitor or the like connected outside may be used as a display means. In such the case, it is constructed such that a display control indication signal is sent to a display means such as a monitor via a video card, a VGA cable, a DVI cable, a BNC cable or the like, which are built inside the image display apparatus 1.

Next, a specific method of image display control process in displaying slice images as many as more than the upper limit number of displaying image (i.e. a non-limiting and illustrative example of the present invention) of the display unit 14 will be described in reference of figures.

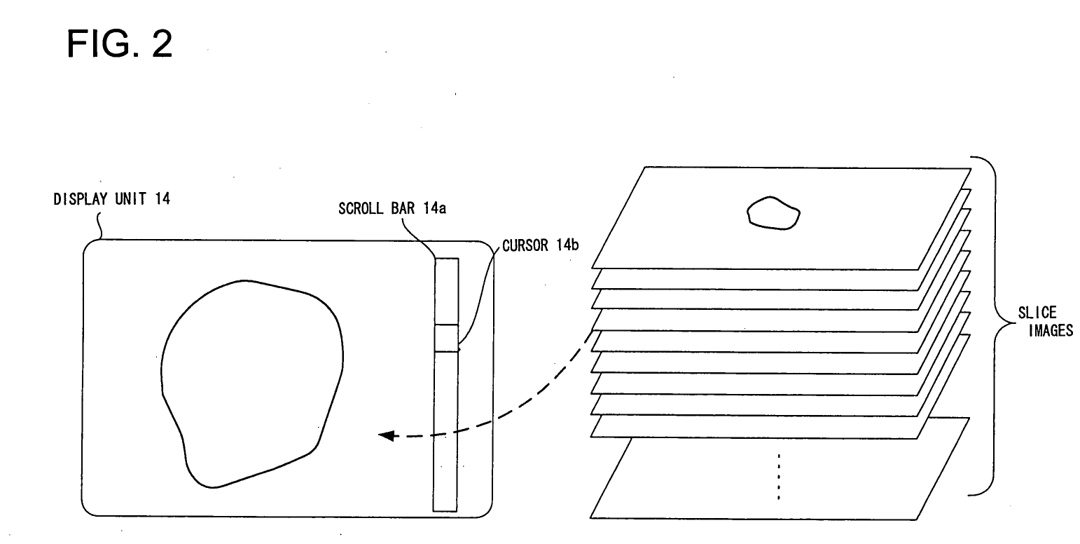

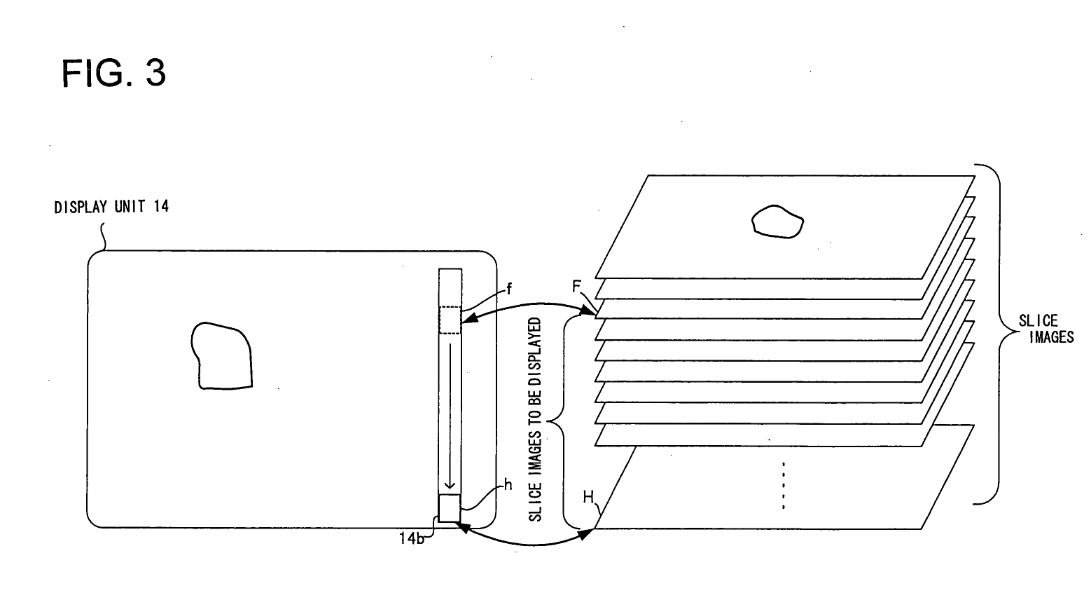

FIGS. 2 and 3 are explanatory views of indicating a mode that a slice image to be displayed is designated out of a plurality of slice images which are memorized in the image memory unit 13A.

When a user operates the operation unit to move the cursor 14 along the scroll bar 14a on the display unit 14, the slice image desired to move is designated out of the plurality of slice images which are memorized in the image memory unit 13A. In this embodiment, it is configured to display the slice image (slice images to be displayed) which corresponds to the position of the cursor 14b on the scroll bar 14a is displayed. By configuring as such, it is possible to display image by identifying a portion of the object to be examined which is desired to be displayed out of the plurality of images, acquired by scanning the object to be examined.

Further, as shown in FIG. 3, when the cursor 14b is moved from position f to position h on the scroll bar, slice images of from the F-th sheet corresponding to the cursor position f to the H-th sheet corresponding to the cursor position h become the plurality of target slice images to be displayed on the display unit 14. The plurality of target slice images to be displayed of from the F-th sheet to the H-th sheet are sequentially displayed on the display unit 14.

At this time, it is judged whether or not the number of the slice images to be displayed of from the F-th sheet to the H-th sheet is within the upper limit number of displaying image per second in the display unit 14. Namely, in a case where the upper limit number of displaying image per second is 60 sheets per second on the basis of display processing capability of the display unit 14, and the cursor 14b is moved from the position f to the position h on the scroll bar within a second, it is possible to display all target slice images to be displayed on the display unit 14 as long as the number of target slice images is 60 (sixty) or less. However, if the number is more than 60 sheets, it is impossible to display all the target slice images within the cursor 14b moves up to the position h. In such the case, the number of the target slice images is configured to match the upper limit number of displaying image per second in the display unit 14. Specifically, among a plurality of target slice images, several target slice images are pick up and combined to produce one synthesis image. The synthesis image is displayed instead of the target slice images (hereinafter, referred to as a synthesis target slice image) which are originally provided.

Hereinafter, a image display control procedure carried out by the control unit 11 will be described in reference of a flow chart.

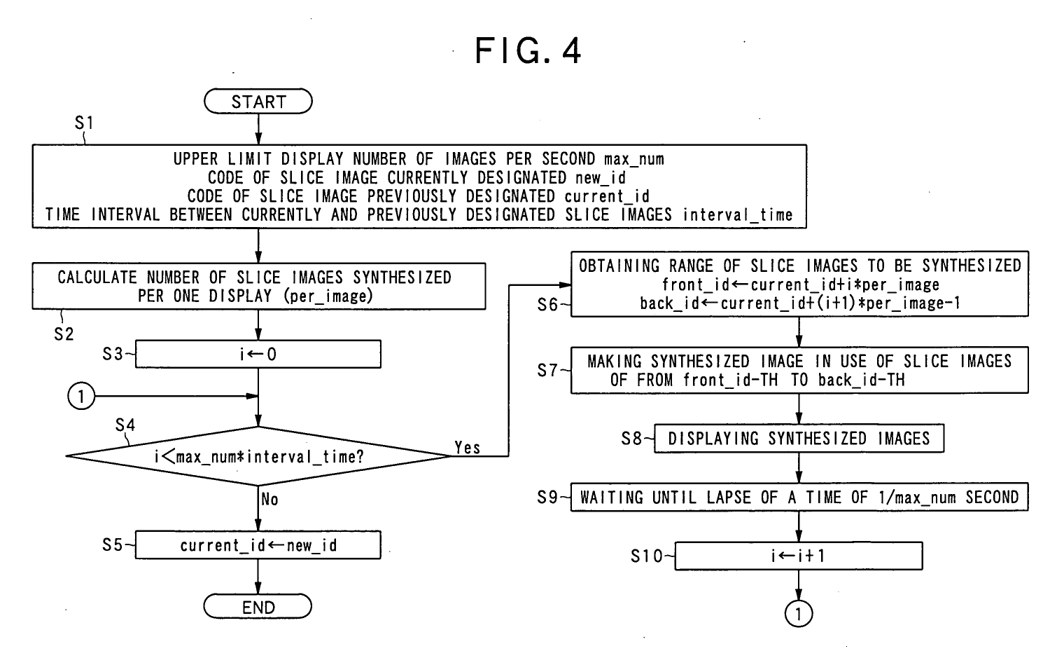

FIG. 4 is a flow chart for showing an image display control process. The process is carried out when an image display program is executed with the control unit 11 of the image display apparatus 1. When the user operates the operation unit 15 to designate the plurality of target slice images by moving the position of the cursor 14b (a display planar image designating means), execution of this process is initiated.

First, the control unit 11 functions as a display limit information obtaining means. The control unit 11 obtains an upper limit number of displaying image per second as an example of display limit information and initializes the upper limit number of displaying image per second as “max_num”, an identification code of slice image currently designated as “new_id”, an identification code of slice image previously designated as “current_id”, and a time interval between the previous designation and the current designation as “interval_time” in Step S1.

The upper limit number of displaying images per second in the display unit 14 may be previously set up in and stored in the memory unit 13 so as to be obtained. Or it may be configured such that the user designates the upper limit number of displaying images per second when the user operates the operation unit 15 so as to guarantee that a time for displaying an image is long enough for the user to observe the image. Or, a limit of frame rate in the display unit 14 may be used as the upper limit number of displaying images. Next, the control unit 11 functions as a synthesis rate obtaining means and calculates a number per_image of slice images to be synthesized at each display on the basis of the upper limit number of displaying images per second max_num in the display unit 14. (Step 2) Specifically, number of synthesizing slice image sheets (synthesis rate) to be displayed is calculated in accordance with the following Formula 1.

per_image=(new_id−current_id)/max_num/interval_tim e (when new_id−current_id is negative, per_image also has a negative value) [Formula 1]

In the next, a parameter i is initialized as 0 (Step 3). In the next, the control unit 11 works as a display ability judgment means thereby judging whether or not a parameter i is less than (max_num*interval_time) in Step S4.

When it is judged that the parameter i is not less than (max_num*interval_time) along NO in Step S4, code new_id of a slice image currently designated is substituted by code current_id of a slice image previously designated in Step S5. Then the process is completed.

Meanwhile, when it is judged that the parameter i is less than (max_num*interval_time) along YES in Step S4, a range of the slice images (slice image to be synthesized and displayed) to be synthesized is obtained in accordance with Formulas 2 and 3 in Step S6.

front_id=current_id+i*per_image−1 [Formula 2]

back_id=current_id+(i+1)*per_image− [Formula 3]

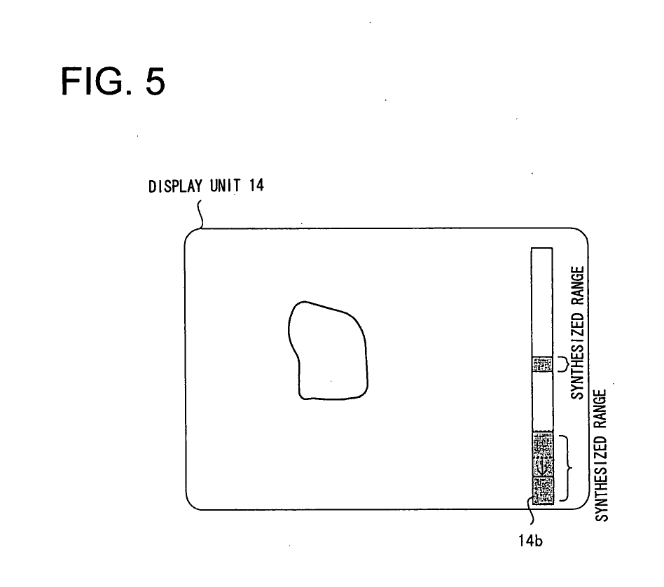

In these formulas, front_id and back_id designate code of slice images to be synthesized and displayed among the target display slice images. Slice images contained between the code front_id and the code back_id are slice images to be synthesized (i.e. synthesis target slice images). Accordingly, the control unit 11 functions as a synthesizing means, and a synthesis image is formed in use of the slice images at from the position of front_id to the position of back_id are used to form a synthesis image in Step S7. A means for producing the synthesis image may be realized, for example, by rendering an average value of pixel values of each pixel on synthesis target slice images at positions between front_id and back_id, corresponding to a coordinate of (x, y) to be a pixel value of a pixel positioned at the coordinate (x, y)of the synthesis image. Or, the means for producing the synthesis image may be realized by rendering a maximum value of pixels on each of the synthesis target slice images at positions between front_id and back_id, corresponding to a coordinate of (x, y) to be the pixel value of pixel positioned at the coordinate (x. y) of the synthesis image, as MIP(Maximum Intensity Projection). Or, the means for producing the synthesis image may be realized by rendering a minimum value of pixel values of each pixel on synthesis target slice images at positions between front_id and back_id, corresponding to a coordinate of (x, y) to be the pixel value of pixel positioned at the coordinate (x, y) of the synthesis image, as MinIP (Minimum Intensity Projection). Further, a synthesis rate in making the synthesis images may not be uniform with respect to all the synthesis target slice images, and weighted average synthesis may be applied. This is because the synthesis rate per_image generally is a real number. For example, when per_image is given as a real number, and front_id and back_id are calculated as integers, there is a case where values of from the back_id to the front_id, which are actually composed by i in synthesizing as many as i of the target slice images at from the positions of back_id to the front_id, are rounded like 2, 2, 1, 2, 1, 1, 2, . . . . Meanwhile, when per_image is given as a real number, and the front_id and the back-_id are calculated as the real number, the value between the front_id and the back_id are calculated as real numbers, the values of between the back_id and front_id, being a number of actually synthesizing as many as i do not change thereby being 1.5, 1.5, 1.5, 1.5, 1.5, . . . . Therefore, it is preferable to carry out a weighted average synthesis when the front_id and the back_id are calculated as real numbers. Further, when the synthesis is carried out, it is possible to constitute such that slice number used in forming the synthesis target slice image may be displayed to present number of slice images used for synthesizing it to a user. By this, the user can objectively judge a degree of degeneration in an image caused by synthesis. Furthermore, it is possible to present a range of slice images thus synthesized not only by displaying the sheet number of slice images but also by coloring the range of the slice images thus synthesized on a scroll bar (vide FIG. 5).

In the next, the synthesis image thus formed is displayed on the display unit 14 in Step S8, and it is waited after a lapse of 1/max_num second (Step S9), one is added to a variable i in Step S10, and the process returns to Step S4.

As described, according to the above-described embodiment, it is judged whether or not the display slice image designated can be displayed based on whether or not the number of the slice images to be displayed which is designated by a user exceeds the upper limit number of displaying image per second in the display unit 14. Even in a case where all the slice images cannot be displayed on the display unit 14 because the number of the slice images to be displayed exceeds the upper limit number of displaying image per second on the display unit 14, the display slice image is composed in a synthesis rate based on the upper limit number of displaying image and is displayed as the synthesis image instead of the display slice images. Further, when the user wishes to decrease speed of operation or stop the operation, because the number of the display slice images is lower than the upper limit number of displaying image, original slice images without synthesizing these are automatically displayed. Therefore, when a user wishes to meticulously interpret images, original images are displayed without enormous operation and therefore the user can efficiently carry out diagnosis.

Further, when number of the slice images (i.e. slice images of positions between front_id and back_id) obtained in Step S6 and to be synthesized is a predetermined number or more (i.e. synthesis rate is the predetermined number or more), it is possible to provide an upper limit to the number of slice images to be synthesized so that the number is less than a predetermined sheet number (i.e. synthesis rate is less than the predetermined number). At this time, it is possible to constitute such that the limit of synthesis rate is set up with respect to regions of an object to be examined.

Furthermore, slice images which are improper to mutually combine are emitted from synthesis with synthesis adequacy judgment means. For example, when there are slice images of which scanned times are apart by a predetermined threshold time or more, these slice images are removed from the synthesis. Namely, because slice images are obtained on the basis of three-dimensional information obtained by scanning an object to be examined, which is laid down on a table or the like, when scanned times are apart by the predetermined time or more, various scanning conditions such as conditions of the object to be examined may change. Therefore, it is improper to combine slice images having such the different scanning conditions. Accordingly, it is preferable that scanned time information is in advance memorized in correspondence with a slice image in the image memory unit 13A. By this, the control unit 11 obtains the scanned time information of the slice image to be synthesized out of the image memory unit 13A, and the control unit 11 is constituted to omit the slice image having the scanned time apart by the threshold value or more and use only slice images having scanned times within the threshold value to produce a synthesis image. Such the constitution is especially effective in a case where scanning is carried out in synchronism with heartbeat and/or respiration. Furthermore, in a case of images obtained with an MRI scanner, type of the images may be different depending on type of slice images such as T1 weighted image, T2 weighted image, and diffusion (weighted) image. In such the case it is also preferable to prevent different types from being synthesized.

Further, in the above-mentioned embodiment, although a limit display number of image determined based on display processing capability of the display unit 14 is rendered to be the upper limit display number of image, it may be possible to constitute to enable designation (set up) of an upper limit display number of image or to determine upper limit display numbers with respect to regions of object to be examined by a user's operation of an operation unit 15. This is because speed of recognizing visual information is different with respect to users, and a time necessary for recognizing lesion is different with respect to body tissues.

Further, in the above-described embodiment, since the slice images are constituted to be stored in the image memory unit 13A, in a case of taking in a plurality of slice images via network and a communication unit 12 from a database or a server, which extracts and accumulates the plurality of slice images out of three dimensional information of an object, instead of using the image memory unit 13A, to thereby sequentially display the slice images, the upper limit display number of image may be determined based on the basis of transfer speed (communication speed) of the slice images in the network. Further, when sheet number of slice images to be transmitted at an identical transfer speed dynamically changes by compression of the images, upper limit display number of planar image may be dynamically changed. Furthermore, when sheet number of slice images to be transmitted changes by, for example, congestion of communication line, the upper limit display number of planar image may be dynamically changed.

Further, in the above-described embodiment, although the slice image of a planar image in an axial direction of the object to be examined, which is obtained from the three dimensional information of the object to be examined, is used, the present invention is not limited thereto. For example, the slice image may be a planar image in a coronal or sagittal direction obtained from the three dimensional information of the object to be examined. Further, in general, it is also possible to apply a Multi Planar Reconstruction (MPR) image, which can provide an arbitrary cross-sectional planar image of three dimensional information (volume data) made up of a group of slice images, to the planar image according to the present invention. In this, a MPR images includes not only an image which visualizes only information on the arbitrary cross section, but also an image which visualizes information contained in a plane-like space having a thickness and including upper and lower regions of the arbitrary cross section. A method for visualizing the plane-like space with thickness is, for example, to form planar image information by obtaining an average value, a maximum value, and a minimum value with respect to a vertical direction. When this method is applied to the MPR image, a plurality of MPR images of a plurality of cross-sections parallel to an arbitrary cross-section that defines the MPR image correspond to the plurality of planar images in the embodiment. Further, for example, a Curved MPR (CMPR), which is obtainable by cutting through a curved planar along a center line of tube like vessel, can also be applied to the planar images of the present invention.

Further, the above-described program corresponding to a flow chart shown in FIG. 4 may be recorded on an information recording medium such as a flexible disc and a hard disc. By reading out the program by a general-use computer and conducting the program, it is possible to cause the computer function as the control unit 11 according to the embodiment.

According to the present invention, even though it is judged that a plurality of target planar images cannot be displayed after judging whether or not it is possible to display the plurality of target planar images to be displayed, it is possible to provide an image display control apparatus or the like which can produce a synthesis image by combining the plurality of target planar images to be displayed while dynamically obtaining a synthesis rate based on an upper limit number of displaying image and efficiently display the plurality of target planar images to be displayed without loss.

As described, the present invention can be used in a field of display control method for displaying a plurality of planar images on a display means. Especially, when it is applied to a field of image display control in displaying an image exceeding an upper limit of the display means on the display means, a prominent effect is obtainable.

The present invention is not confined to the configurations listed in the foregoing embodiments, but it is easily understood that the person skilled in the art can modify such configurations into various other modes, within the scope of the present invention described in the claims.

The entire disclosures of Japanese Patent Applications No. 2006-334936 filed on Dec. 12, 2006 including the specification, claims, drawings and summary are incorporated herein by reference in its entirety.

What is claimed is:

1. An image display controlling apparatus for displaying three-dimensional information of an object to be examined on a display means, comprising:
a planar image acquiring means for acquiring a plurality of planar images from the three-dimensional information;
a display planar image designating means for designating a plurality of target planar images to be displayed included in the plurality of planar images;
a display limit information obtaining means for obtaining display limit information indicative of an upper limit number of planar images displayed per a predetermined time with the display means;
a display ability judgment means for judging whether or not it is possible to display the plurality of target planar images on the basis of the display limit information;
a synthesis rate obtaining means for obtaining, when it is judged that display is impossible by the display ability judgment means, a synthesis rate for converting a number of the planar images per the predetermined time on the basis of the upper limit number of displaying the planar images to a number less than the upper limit number of displaying planar images;
a synthesizing means for producing a plurality of synthesis images by synthesizing the plurality of target planar images in use of the synthesis rate; and
a display control means for displaying the plurality of synthesis images thus produced on the display means.

2. The image display controlling apparatus according to claim 1, wherein
the synthesizing means includes a synthesis adequacy judgment means for judging whether or not it is inadequate to synthesize a specific set of target planar images out of the plurality of target planar images, and excludes the specific set of target planar images from the synthesis when it is judged to be inadequate.

3. The image display controlling apparatus according to claim 1, wherein
the display planar image designating means includes a synthesis rate limiting means to make a synthesis rate less than a predetermined number when the synthesis rate of a predetermined number or more is detected.

4. The image display controlling apparatus according to claim 1, wherein
the display control means displays the synthesis rate on the display means.

5. The image display controlling apparatus according to claim 1, wherein the synthesizing means produces the synthesis image by using an average value, a maximum value, or a minimum value of pixels forming the target planar image.

6. The image display controlling apparatus according to claim 1, wherein the planar image is an MPR image of the object to be examined.

7. The image display controlling apparatus according to claim 6, wherein the planar image is a planar image in any one of directions of axial, coronal, and sagittal.

8. The image display controlling apparatus according to claim 1, wherein the display planar image designating means designates the target planar image out of the plurality of planar images upon operation of the operation means by a user.

9. The image display controlling apparatus according to claim 1, wherein the upper limit number of displaying planar image per a predetermined time is designated when the user operates the operating device.

10. The image display controlling apparatus according to claim 1, wherein the plurality of planar images are obtained from another computer through a network, and the upper limit number of displaying planar images per the predetermined time is determined by at least a transfer speed of the network.

11. A computer program embodied in a computer-readable medium and representing a sequence of instructions, which when executed by a computer included in an image display controlling apparatus for displaying three-dimensional information of an object to be examined on a display means, the instructions cause the computer to function as:
a planar image acquiring means for acquiring a plurality of planar images from the three-dimensional information;
a display planar image designating means for designating a plurality of target planar images to be displayed included in the plurality of planar images;
a display limit information obtaining means for obtaining display limit information indicative of an upper limit number of displaying the planar images per a predetermined time with the display means;
a display ability judgment means for judging whether or not it is possible to display the plurality of target planar images on the basis of the display limit information;
a synthesis rate obtaining means for obtaining, when it is judged that display is impossible by the display ability judgment means, a synthesis rate for converting a number of the planar images per the predetermined time on the basis of the upper limit number of displaying the planar images to a number less than the upper limit number of displaying planar images;
a synthesizing means for producing a synthesis image by synthesizing the plurality of target planar images in use of the synthesis rate; and
a display control means for displaying the synthesis image thus produced on the display means.

12. An image display controlling method of displaying three-dimensional information of an object to be examined on a display means, comprising:
a planar image acquiring step of acquiring a plurality of planar images from the three-dimensional information;
a display planar image designating step of designating a plurality of target planar images to be displayed included in the plurality of planar images;
a display limit information obtaining step of obtaining display limit information indicative of an upper limit number of displaying the planar images per a predetermined time in the display means;
a display ability judgment step of judging whether or not it is possible to display the plurality of target planar images on the basis of the display limit information;
a synthesis rate obtaining step of obtaining, when it is judged that display is impossible in the display ability judgment step, a synthesis rate for converting a number of the planar images per the predetermined time on the basis of the upper limit number of displaying the planar images to a number less than the upper limit number of displaying planar images;
a synthesizing step of producing a plurality of synthesis images by synthesizing the plurality of target planar images in use of the synthesis rate; and
a display control step of displaying the synthesis image thus produced on the display means.
